(19) United States
(12) Patent Application Publication
(10) Pub. No.: US 2024/0257120 A1
(43) Pub. Date: Aug. 1, 2024

(54) DYNAMIC COMPUTING AND ASSIGNMENT OF VARIABLE FEE ON CROSS-BORDER TRANSACTIONS

(71) Applicant: MASTERCARD INTERNATIONAL INCORPORATED, PURCHASE, NY (US)

(72) Inventors: Sumit SAURAV, Pune (IN); Ankurjyoti BORDOLOI, Guwahati (IN); Aayush MITTAL, Kotkapura (IN); Lakshay MARWAHA, Jalandhar (IN)

(21) Appl. No.: 18/163,269

(22) Filed: Feb. 1, 2023

(51) Int. Cl. G06Q 20/38

(52) U.S. Cl. CPC G06Q 20/389; G06Q 20/387

(57) ABSTRACT

Systems and methods dynamically compute and assign a variable fee for cross-border transactions. Raw data associated with a pending transaction is prepared for analysis by a scenario-specific model. The pending transaction is assigned to a scenario. The scenario-specific model generates a recommended variable fee for the pending transaction based on the prepared data. The recommended variable fee is output to an issuer processing the pending transaction. Feedback is received from the issuer regarding the recommended variable fee and the scenario-specific model is trained using the received feedback.

### BACKGROUND

A cross-border transaction, also referred to herein as a foreign transaction, is a transaction that occurs in a country other than a user's home country. For example, for a user with a card issued in the United States, a foreign country would be any country other than the United States. Some providers that authorize and process transactions using payment cards, such as credit cards or debit cards, charge an additional fee for foreign transactions. This additional fee accounts for transaction processing in cross-border and/or cross-currency scenarios, such as a conversion from the local currency, where the transaction is, to the home currency in which the card was issued, or vice versa.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various implementations of the present disclosure described herein are directed to systems and methods for dynamically computing and assigning a variable fee for cross-border transactions. The method includes preparing raw data for analysis by a scenario-specific model. The raw data is associated with a pending transaction. The pending transaction is assigned to a scenario. The scenario-specific model generates a recommended variable fee for the pending transaction based on the prepared data. The recommended variable fee is output to an issuer processing the pending transaction.

In another implementation, a system for dynamically computing and assigning a variable fee for cross-border transactions includes a processor, a communications interface, and a memory. The memory stores instructions that, when executed by the at least one processor, cause the at least one processor to prepare raw data for analysis by a scenario-specific model. The raw data is associated with a pending transaction, and the plurality of transactions includes a pending transaction. The instructions further cause the processor to rank the plurality of transactions based on a ratio of maximum approved transaction amounts to fraud likelihood for each transaction, the ranking including a first tier of transactions, a second tier of transactions, and a third tier of transactions, assign the pending transaction to a scenario based on the ranking, generate, by the scenario-specific model implemented on the processor, a recommended variable fee for the pending transaction based on the processed data, and transmit, over a network, the recommended variable fee to an issuer processing the pending transaction.

In another implementation, a computer readable medium stores instructions for dynamically computing and assigning a variable fee for cross-border transactions. The instructions, when executed by a processor, cause the processor to prepare raw data for analysis by a scenario-specific model, the raw data associated with a pending transaction, and the plurality of transactions including the pending transaction, rank the plurality of transactions based on a ratio of maximum approved transaction amounts to fraud likelihood for each transaction, the ranking including a first tier of transactions, a second tier of transactions, and a third tier of transactions, assign the pending transaction to a scenario based on the ranking, generate, by the scenario-specific model implemented on the processor, a recommended variable fee for the pending transaction based on the processed data, output the recommended variable fee to an issuer processing the pending transaction, receive feedback from the issuer regarding the recommended variable fee, and train the scenario-specific model using the received feedback.

### BRIEF DESCRIPTION OF THE DRAWINGS

The present description will be better understood from the following detailed description read in light of the accompanying drawings, wherein:

FIG. 1 illustrates an example system for dynamically computing a variable fee for cross-border transactions;

FIG. 2 is a block diagram illustrating an example system for dynamically computing a variable fee for cross-border transactions;

FIG. 3 is a block diagram illustrating an example artificial intelligence (AI) model for dynamically computing a variable fee for cross-border transactions;

FIG. 4 is an example computerized method of dynamically computing a variable fee for cross-border transactions;

FIG. 5 is an example computerized method of executing a model that dynamically computes a variable fee for cross-border transactions in a scenario;

FIGS. 6A-6B are an example computerized method of executing a machine learning (ML) model that dynamically computes a variable fee for cross-border transactions in a scenario;

FIG. 7 is an example computerized method of executing a ML model that dynamically computes a variable fee for cross-border transactions in a scenario; and

FIG. 8 is a block diagram of an example computing device for implementing implementations of the present disclosure.

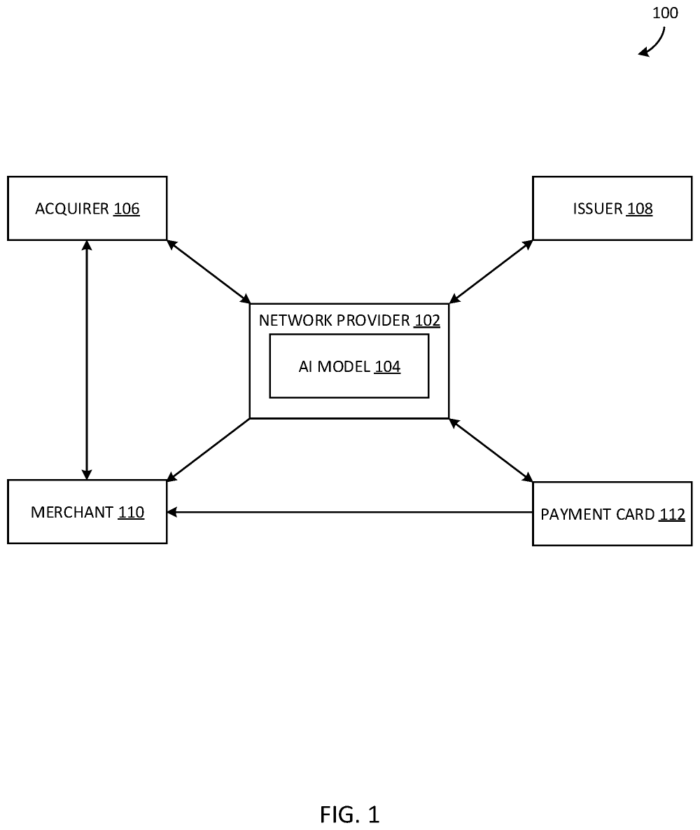

Corresponding reference characters indicate corresponding parts throughout the drawings. In FIGS. 1 to 8, the systems are illustrated as schematic drawings. The drawings may not be to scale.

### DETAILED DESCRIPTION

The various implementations and examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

Estimated fees for cross-border transactions are provided when a user establishes an account with a provider, but in some situations the fee differs based on the amount of the transaction, category of the transactions, region of the transaction, and so forth. Current solutions for calculating the variable fee for a cross-border transaction fail to calculate an optimal variable fee for several reasons. For example, some solutions utilize a static variable fee that is applied by the issuer, which fails to take into account transaction-specific variables such as category of transaction, region of the transaction, amount of the transaction, and so forth. Other solutions may not have sufficient visibility, or capability, to determine which variable fee should be applied for a specific transaction or category of transactions, or do not have access to the data insights to determine the variable fee based on anything other than incomplete market and business understandings.

The present disclosure addresses these issues by providing an artificial intelligence (AI) based intelligent variable fee recommendation engine that generates a recommended fee that optimizes profit for an issuer within the provider agreement while improving the customer experience. The recommendation engine uses key data points as input, including issuer details, transaction details, merchant details, fraudulent data indicators, variable fee details, historical data, and so forth in order to investigate one or more areas for variable fee recommendations. Thus, the scenario-specific machine learning (ML) models provided in the present disclosure provide a technical solution that enables improved management of computational resources by dynamically computing the variable fee more accurately, in real-time, and more efficiently by utilizing fewer processor cycles than existing solutions. The scenario-specific ML models further enable the provider to profit or recover operational, or service, costs without impacting the customer experience, and the automatic ingestion of the variable fee directly into data elements in real-time enables a feedback loop that continually improves the accuracy of the calculated variable fees based on historical data and real-time feedback.

The technical solution of scenario-specific machine learning (ML) models is implemented in an unconventional manner at least by assigning a transaction to a scenario based on a tiered ranking that is formulated using a ratio of the transaction amount and likelihood of fraud, and executing the different ML model that is tied to one of the tiers in order to accomplish a specific purpose with the variable fee. For example, one ML model identifies a group of issuers and generates a similar variable fee to that generated by the other issuers, another model generates a minimal variable fee, and yet another ML model generates a variable fee to either recover operational costs or generate a profit. In some examples, assigning a particular transaction to a particular scenario, and therefore a particular model for calculating the variable fee, reduces the bandwidth and computing power required to generate the variable fee by identifying a single model to be used to generate the variable fee, and reduces the amount of time required to compute the variable fee. In other words, as opposed to implementing multiple models for a single transaction and identifying an optimal fee between the multiple models, implementations of the present disclosure reduce the computing power required to generate the recommended variable fee by first identifying a particular model to be used to generate the variable fee prior to executing the model.

As referenced herein, the variable fee is an additional fee that is charged in cross-border and/or cross-currency transactions for transaction processing. In some examples, the variable fee is a rate, or percentage, of the total transaction amount. In some examples, the variable fee is a flat amount per transaction rather than a rate. One or more embodiments described herein provide a mechanism of determining the variable fee to be applied to a particular transaction.

FIG. 1 illustrates an example system for dynamically computing a variable fee for cross-border transactions. The system 100 illustrated in FIG. 1 is provided for illustration only. Other examples of the system 100 can be used without departing from the scope of the present disclosure.

The system 100 includes a network provider 102, an acquirer 106, an issuer 108, a merchant 110, and a payment card 112. The network provider 102 facilitates and processes transactions initiated using the payment card 112 by a cardholder, or user. For example, the payment card 112 is presented to the merchant 110 as part of a transaction where the cardholder purchases goods or services from the merchant 110. It should be understood that the example of a payment card 112 is presented for illustration only and should not be construed as limiting. For example, the payment card 112 may be presented electronically, such as in an online transaction, identifiers of the payment card 112, such as the card number, may be presented over the phone to the merchant, or the payment card 112 may be presented to the merchant in an electronic wallet provided by an electronic device.

In some examples, the payment card 112 is associated with a particular account. The account includes personal information regarding the account holder including a name, contact information including an address, phone number, electronic mail (e-mail) address, and so forth, information regarding each payment card 112 associated with the account, payment information, billing information, and so forth. In some examples, the personal information includes a home country of the account holder. In other examples, the home country is derived from the address included in the contact information. In some examples, the account is established and serviced by the network provider 102. In other examples, the account is established and serviced by a third party.

The payment card 112 may be used in transactions that are both intra-border and cross-border. Intra-border transactions are transactions that are processed within the borders of the country designated as the home country of the account holder. For example, where the home country is designated as the United States of America, an intra-border transaction is a transaction processed between the cardholder and another business or individual, such as the merchant 110, who also resides within the United States of America. In contrast, a cross-border transaction is a transaction involving the cardholder that is processed in a country other than the home country of the cardholder, which is the country in which the payment card is issued. For example, where the home country of the cardholder is designated as the United States of America, a cross-border transaction is a transaction processed between the cardholder and another business or individual, such as the merchant 110, who resides in any country other than the United States of America. As referenced herein, a transaction is processed in the home country of the merchant or an acquiring bank of the merchant included in the transaction. For example, a transaction may be considered a cross-border transaction where the cardholder makes an electronic purchase from a merchant 110 in a home country other than the country in which the payment card was issued, even though the cardholder and the payment card 112 never leave the home country of the account holder.

As described herein, cross-border transactions may be subject to additional fees relative to intra-border transactions. For example, service agreements for an account that includes the payment card 112 include provisions that cross-border transactions are charged an additional fee proportional to the charged amount of the transaction to account for a conversion from the local currency, where the transaction is processed, to the home currency of the country in which the payment card was issued, or vice versa, to account for international fees charged to the network provider 102 by the bank of the merchant 110, and so forth. In some examples, the fee is charged at a variable fee.

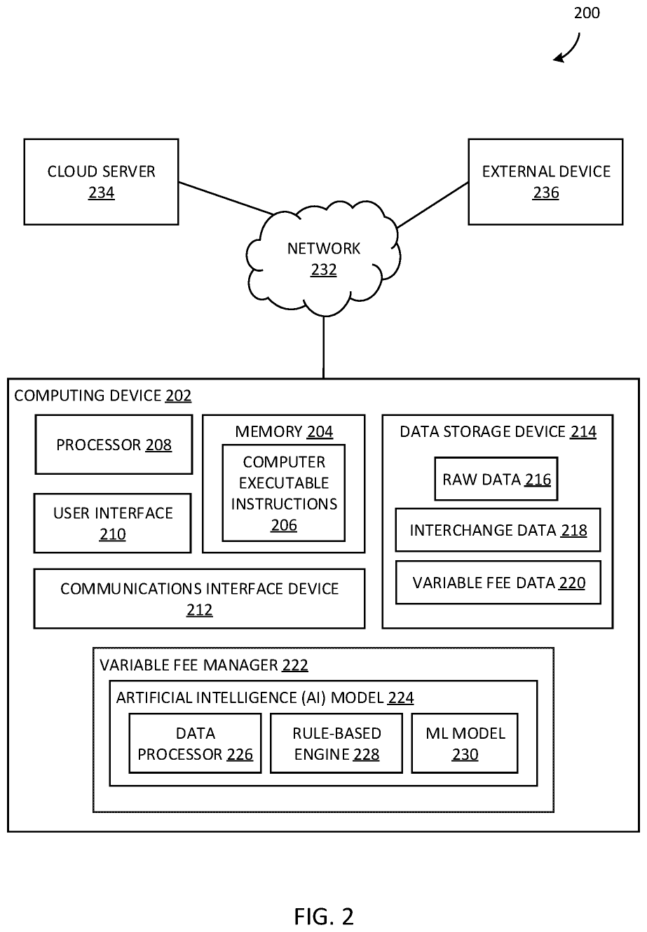

The network provider 102 facilitates and processes the transaction between the payment card 112 and one or more merchants 110. The network provider 102 includes an artificial intelligence (AI) model 104 that determines the variable fee for a particular transaction in real-time. As described in greater detail below with regards to the description of FIGS. 2-7B, the AI model 104 dynamically computes and assigns the variable fee that is charged in cross-border transactions.

The acquirer 106 is a financial institution that serves the merchant 110, while the issuer 108 is a financial institution that serves the account associated with the payment card 112. The acquirer 106 provides one or more accounts to the merchant 110, which enables the merchant 110 to process transactions such as the transaction between the merchant 110 and the payment card 112. In some examples, the acquirer 106 communicates with the issuer 108 via the network provider 102 to facilitate the payment for the transaction between the merchant 110 and the payment card 112. In some examples, the acquirer 106 and the issuer 108 are different financial institutions, such as different banks.

In order to process the transaction between the merchant 110 and the payment card 112, the acquirer 106 sends an authorization request to the network provider 102 that includes a transaction amount. The network provider 102 determines the variable fee for the transaction, if applicable, and forwards the authorization request, including an estimated variable fee, to the issuer 108. The issuer 108 sends a response, including whether to authorize or deny the transaction, to the network provider 102, which forwards the response to the acquirer 106. To clear the transaction, the acquirer 106 submits a clearing file and the network provider 102 applies a final variable fee, selected by the issuer 108 if applicable, to the billing amount and sends the billing amount to the issuer 108. To settle the transaction, the issuer 108 is debited the amount owed to the acquirer 106 and credited the selected variable fee in addition to a currency interchange amount. The network provider 102 credits the acquirer 106 the amount owed by the issuer 108 minus the currency interchange amount.

In some examples, the issuer 108 determines whether to apply a variable fee to cross-border transactions and, if so, determines the variable fee to use. Where the issuer 108 has opted in to a tool provided by the network provider, such as a cross-border fee manager (CBFM) tool, the AI model 104 of the network provider generates a recommended variable fee for the particular transaction and outputs the recommended variable fee to the issuer 108. The issuer 108 selects to apply the recommended variable fee or not to apply the recommended variable fee and returns an indication of the selection to the AI model 104 as feedback to further train one or more aspects of the AI model 104, as described in greater detail below. In some examples, the initial authorization request from the acquirer 106 to the issuer 108 includes a preliminary, estimated variable fee. When the transaction clears, the clearing file includes the variable fee that is selected by the issuer 108, which may differ from the estimated variable fee included in the authorization request.

FIG. 2 is a block diagram illustrating an example system for dynamically computing a variable fee for cross-border transactions. The system 200 illustrated in FIG. 2 is provided for illustration only. Other examples of the system 200 can be used without departing from the scope of the present disclosure.

The system 200 includes a computing device 202, a cloud server 234, and an external device 236. Each of the computing device 202, the external device 236, and the cloud server 234 are communicatively coupled to and communicate via a network 232. The computing device 202 represents any device executing computer-executable instructions 206 (e.g., as application programs, operating system functionality, or both) to implement the operations and functionality associated with the computing device 202. The computing device 202, in some examples, is a device executed in the cloud. In some examples, the computing device 202 includes a mobile computing device or any other portable device. A mobile computing device can include servers, desktop computers, kiosks, IoT devices, or tabletop devices. Additionally, the computing device 202 can represent a group of processing units or other computing devices. In some examples, the computing device 202 is an example of the network provider 102.

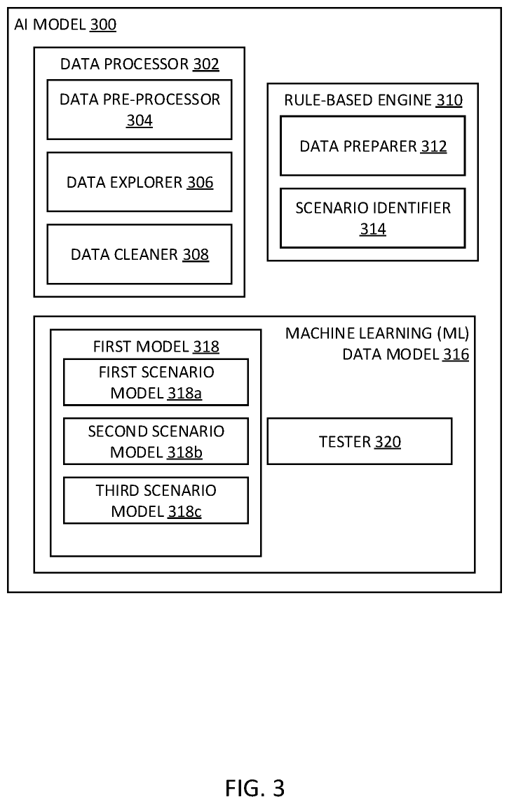

In some examples, the computing device 202 includes at least one processor 208, a memory 204 that includes the computer-executable instructions 206, and a user interface 210. The processor 208 includes any quantity of processing units, including but not limited to a CPU or units, a graphics processing unit (GPU) or units, and a neural processing unit (NPU) or units. The processor 208 is programmed to execute the computer-executable instructions 206. The computer-executable instructions 206 are performed by the processor 208, performed by multiple processors within the computing device 202, or performed by a processor external to the computing device 202. In some examples, the processor 208 is programmed to execute computer-executable instructions 206 such as those illustrated in the figures described herein, such as FIGS. 3-7. In various examples, the processor 208 is configured to execute one or more of the communications interface device 212, data storage device 214, and variable fee manager 222 as described in greater detail below. In other words, the communications interface device 212, data storage device 214, and variable fee manager 222 are implemented on and/or by the processor 208.

The memory 204 includes any quantity of media associated with or accessible by the computing device 202. The memory 204 in these examples is internal to the computing device 202, as illustrated in FIG. 2. In other examples, the memory 204 is external to the computing device 202 or both internal and external to the computing device 202. For example, the memory 204 can include both a memory component internal to the computing device 202 and a memory component external to the computing device 202. The memory 204 stores data, such as one or more applications. The applications, when executed by the processor 208, operate to perform various functions on the computing device 202. The applications can communicate with counterpart applications or services, such as web services accessible via the network 232. In an example, the applications represent downloaded client-side applications that correspond to server-side services executing in a cloud, such as the cloud server 234.

The user interface 210 includes a graphics card for displaying data to a user and receiving data from the user. The user interface 210 can also include computer-executable instructions, for example a driver, for operating the graphics card. Further, the user interface 210 can include a display, for example a touch screen display or natural user interface, and/or computer-executable instructions, for example a driver, for operating the display. The user interface 210 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor.

The communications interface device 212 includes a network interface card and/or computer-executable instructions, such as a driver, for operating the network interface card. Communication between the computing device 202 and other devices, such as but not limited to the cloud server 234, can occur using any protocol or mechanism over any wired or wireless connection. In some examples, the communications interface device 212 is operable with short range communication technologies such as by using NFC tags or RFID.

The computing device 202 further includes a data storage device 214 for storing data, such as, but not limited to raw data 216, interchange data 218, and variable fee data 220. The data storage device 214, in this example, is included within the computing device 202, attached to the computing device 202, plugged into the computing device 202, or otherwise associated with the computing device 202. In other examples, the data storage device 214 includes a remote data storage accessed by the computing device 202 via the network 232, such as a remote data storage device, a data storage in a remote data center, or a cloud storage.

The raw data 216 is data that is received and not yet processed, explored, or cleaned. For example the raw data 216 includes one or more of issuer details, including an identifier, name, address, and account information, merchant details, including an identifier, name, address, and account information, acquirer details, including an identifier, name, address, and account information, cardholder details, including an identifier, name, address, and account information, and transaction details, including the cardholder, merchant 110, issuer 108, acquirer 106, location of the transaction, date of the transaction, transaction amount, and transaction category. The interchange data 218 is data related to a currency exchange rate between the home country of the card holder and the country in which the transaction was processed. The variable fee data 220 is data related to the variable fee for cross-border transactions.

In some examples, the raw data 216 is categorized into various parameters including transaction parameters, issuer-specific inputs, and mark-up data. Data categorized as transaction parameters include transaction counts or amounts, number of cross-border transactions, product portfolio, whether the transaction is interregional or intraregional, whether the transaction is a DCC transaction or non-DCC transaction, merchant data including the country, currency, and MCC, and transaction channel. Data categorized as issuer-specified inputs include risky MCC, historical fraud data including the counts and amounts, and spending data including the counts and amount. Mark-up data includes historical variable fees and issuer thresholds.

In some examples, the raw data 216 is further categorized as historical data, real-time data, or both. These categorizations refer to what the data is used to calculate, or compute. For example, historical data is used to pre-compute a variable fee for a transaction and real-time data is used to determine into which category a transaction is categorized through variables such as a segment, fraud, an approved amount, and so forth. Some data is used as both historical data and real-time data. In some examples, transaction counts or amounts, number of cross-border transactions, historical fraud data including the counts and amounts, spending data including the counts and amount, historical variable fees, and issuer thresholds are categorized as historical data, while data such as product portfolio, whether the transaction is interregional or intraregional, whether the transaction is a DCC transaction or non-DCC transaction, merchant data including the country, currency, and MCC, transaction channel, and risky MCC is categorized as both historical and real-time data.

The variable fee manager 222 is a specialized computing processor implemented on the processor 208 that determines the variable fee charged on a cross-border transaction. The variable fee manager 222 includes an AI model 224 that investigates aspects of a particular cross-border transaction and outputs a recommended variable fee for the cross-border transaction. In particular, the AI model 224 investigates different aspects of the cross-border transaction, including peer groups and market benchmarks, segment popularity, profit and operational cost recovery, and thresholds and compliance, in order to create and execute a semi-rule based data driven algorithm based on an identified scenario of the transaction in order to compute a variable fee for the cross-border transaction. The AI model 224 includes a data processor 226, a rule-based engine 228, and a machine-learning (ML) model 230. The data processor 226 prepares data, such as the raw data 216, for analysis by the rule-based engine 228. The rule-based engine 228 identifies a transaction scenario category and the ML model 230 executes a function to identify the variable fee based on the scenario identified by the rule-based engine 228. The AI model 224 and its components will be discussed in greater detail below.

FIG. 3 is a block diagram illustrating an example artificial intelligence (AI) model for dynamically computing a variable fee for cross-border transactions. The AI model 300 illustrated in FIG. 3 is provided for illustration only. Other examples of the AI model 300 can be used without departing from the scope of the present disclosure. In some examples, the AI model 300 is an example of the AI model 224.

The AI model 300 includes a data processor 302, a rule-based engine 310, and a ML data model 316. In some examples, the data processor 302 is the data processor 226, the rule-based engine 310 is the rule-based engine 228, and the ML data model 316 is the ML model 230. The data processor 302 prepares raw data, such as the raw data 216, into a standardized format that can be used as an input for the rule-based engine 310. The data processor 302 includes a data pre-processor 304 that performs initial data pre-processing, a data explorer 306 that explores the data using visualization and statistical techniques, and a data cleaner 308 that prepares the data for further analysis and implementation.

The data pre-processor 304 performs the first level of data processing on the raw data 216. The data pre-processor 304 identifies a data format of the raw data, standardizes the data format of the data to address mismatches in the data format(s) of the raw data 216 so data is in a single, standardized format, and fixes any mismatched data values of the raw data 216. For example, various values in the raw data 216 may be provided in a different format than other values, same data may be duplicated, some data may be missing, some values may not be consistently matched throughout the raw data 216, and so forth. The data pre-processor 304 recognizes and corrects discrepancies in the raw data 216 in preparation for analysis by the rule-based engine 310 and ML data model 316.

The data explorer 306 analyzes the pre-processed data using data visualization and statistical techniques and outputs characterizations of the pre-processed dataset. The output characterizations may include one or more of a size of the data, quantity of the data, and accuracy of the data. The output characterization provides context for the nature of the data. In some examples, the data explorer 306 performs one or more of univariate analysis and bivariate analysis to understand the type and distribution of each variable of the data and to understand the relationship between the variables and the outcome. In some examples, the relationship between the variables and the outcome is the input of variables and the outcome is a previously determined variable fee determined by the AI model 300.

The data cleaner 308 prepares the explored data for analysis and corrects any remaining data that is not in a format suitable for analysis. For example, the data cleaner 308 removes or modifies any data that is identified as an outlier, including data that is incorrect, incomplete, irrelevant, duplicated, or improperly formatted. In some examples, the data cleaner 308 identifies data outliers by implementing one or more of a box plot, interquartile range (IQR), a z-score, a distance from the mean of a particular data point, and so forth. The data cleaner 308 removes or performs an imputation analysis to correct the identified outliers. In some examples, the data cleaner 308 identifies and treats missing data using deletion, mean/median/mode imputation, K-nearest neighbor (KNN) analysis, and so forth.

The rule-based engine 310 determines a transaction scenario category for a particular transaction. In some examples, different variable fees are calculated, or generated, differently and using different models for different scenario categories. The transaction scenario categories include a peer group and market benchmark scenario, a popularity scenario, and a profit and operational cost recovery scenario. Each transaction scenario will be described in greater detail below. The rule-based engine 310 includes a data preparer 312 that prepares transaction data to be input in a scenario identifier 314, and the scenario identifier 314 that determines the transaction scenario category. The data preparer 312 aggregates and filters the data processed by the data processor 302 for dimensions and measures. For example, the data preparer 312 filters the data for dimensions and measures for a transaction including an issuer 108 country, dynamic currency conversion (DCC) value, merchant country, merchant country conversion (MCC), card portfolio, card presenting code, approval amount, fraud rate, and so forth. The data preparer 312 ranks and sorts the transactions in descending order of the approved amounts for the transactions and in ascending order of fraud rates for the transactions. The transactions are then ranked using a measure of the ratio of maximum approved amounts to the likelihood fraud.

The scenario assigner 314 assigns, or identifies, a particular scenario to a transaction based on the rankings based on the ratio of maximum approved amounts to the likelihood fraud. In some examples, the scenario assigner 314 assigns the transaction as a first scenario based on the highest ranking dimensions/categories that have a maximum approved amount and least fraud, a second scenario based on the lowest ranking dimensions/categories that have a maximum fraud and a least approved amount, and a third scenario based on the remaining transactions that have medium approval and fraud amounts. In some examples, the scenario assignations are determined based on preset thresholds for the various scenarios. For example, transactions in the top twenty percent may be assigned as the first scenario, transactions in the bottom twenty percent may be assigned as the second scenario, and transactions in the middle sixty percent may be assigned as the third scenario. However, these example thresholds are presented for illustration only and should not be construed as limiting. The scenario assigner 314 may implement other threshold distributions beyond the 20/60/20 threshold distribution described herein, such as a 10/80/10 threshold distribution, a 15/70/15 threshold distribution, a 25/50/25 threshold distribution, or any other suitable distribution. In some examples, the first scenario is referred to as a popularity scenario, the second scenario is referred to as a cost recovery and profit scenario, and the third scenario is referred to as a peer group and market benchmark scenario.

The ML data model 316 includes a first model 318, and a tester 320. The first model 318 includes three different models, each model associated with a different scenario identified by the scenario assigner 314. Each model of the first model 318 determines a recommended variable fee for a particular transaction. The first model 318 includes a first scenario model 318a that is applied to transactions identified as a first scenario transaction, a second scenario model 318b that is applied to transactions identified as a second scenario transaction, and a third scenario model 318c that is applied to transactions identified as a third scenario transaction.

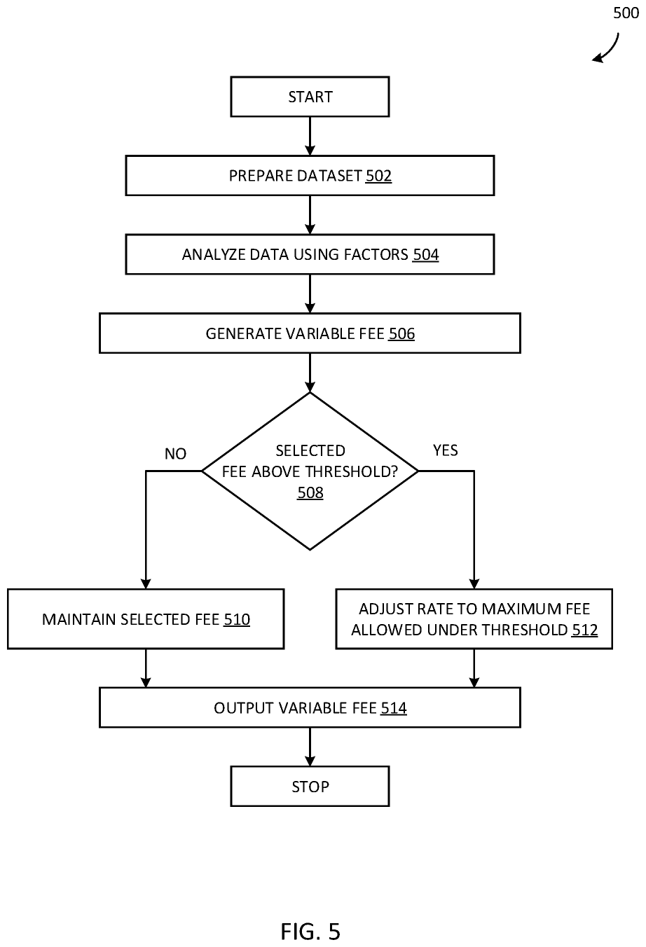

The first scenario model 318a is an analytics-based model that identifies the variable fee for a transaction identified as a first scenario transaction, which is a transaction with the maximum approved amount and least fraud of the ranked transactions. In first scenario transactions, the first scenario model 318a generates a variable fee for the transaction designed to apply a minimum or zero variable fee that is applied to the transaction. The first scenario model 318a includes a data preparation stage and an analysis stage. In the data preparation stage, the first scenario model 318a aggregates the transaction level data at the level of dimensions of the transaction, such as the issuer country, issuer name, DCC, merchant country, MCC, card portfolio, card present code, and mark-up. In the analysis stage, the first scenario model 318a analyzes the data using various factors, including the range of fee applied by the issuer 108 at the selected dimensions, the minimum fee applied by the issuer 108, and the fee applied by all issuers 108 at the selected dimensions, to select an optimal recommended variable fee for the particular transaction. The first scenario model 318a is described in greater detail below with regards to FIG. 5.

The second scenario model 318b is a ML model that identifies the variable fee for a transaction identified as a second scenario transaction, which is a transaction with the least approved amount and the highest fraud of the ranked transactions. In second scenario transactions, the second scenario model 318b generates a variable fee for the transaction designed to either recover operational costs for the transaction or to generate a profit off of the transaction. The second scenario model 318b includes a data preparation stage and a ML model stage. In the data preparation stage, the second scenario model 318b aggregates the transaction level data at the level of dimensions of the transaction, such as the issuer 108 country, issuer 108 name, DCC, merchant country, MCC, card portfolio, card present code, and mark-up. The second scenario model 318b edits the obtained transaction level data to include operational costs for the transaction. The operational cost is the cost incurred by the issuer 108 to service the transaction as a cross-border transaction. Based on the variable fee and the operational cost, the second scenario model 318b labels each row, i.e., each transaction, either a profit transaction, where the variable fee is greater than the operational cost, or a recovery transaction, where the variable fee is equal to the operational cost. The prepared dataset, including the labeled rows, is separated into training data and testing data. In some examples, eighty percent of the prepared dataset is used as training data and twenty percent of the prepared dataset is used as testing data. In other examples, seventy percent of the prepared dataset is used as training data, seventy-five percent of the prepared dataset is used as training data, eighty-five percent of the prepared dataset is used as training data, or any other suitable amount is used as the training data.

In the ML model stage, the second scenario model 318b implements a decision tree ML model that uses a tree-like model of decisions and all possible consequences, including chance event outcomes, resource costs, and utility and identifies a transaction as either a profit transaction or a recovery transaction. Accordingly, the second scenario model 318b takes into account scenarios that may only include conditional control statements. The ML model stage includes a model training phase and a model validation and testing phase. The model training phase trains the ML model on the training dataset prepared in the data preparation stage, in which the ML model executes the decision tree ML model on the training dataset to determine a preliminary variable fee. In the model validation and testing phase, the ML model is tested on the testing dataset prepared in the data preparation stage, in which the ML model is evaluated on one or more metrics including, but not limited to, accuracy, precision, recall, F1 scores, and area under the receiver operating characteristic (ROC) curve (AUC ROC). In some examples, in the model training phase, the ML model further performs hyperparameter tuning to maximize the accuracy of the decision tree ML model.

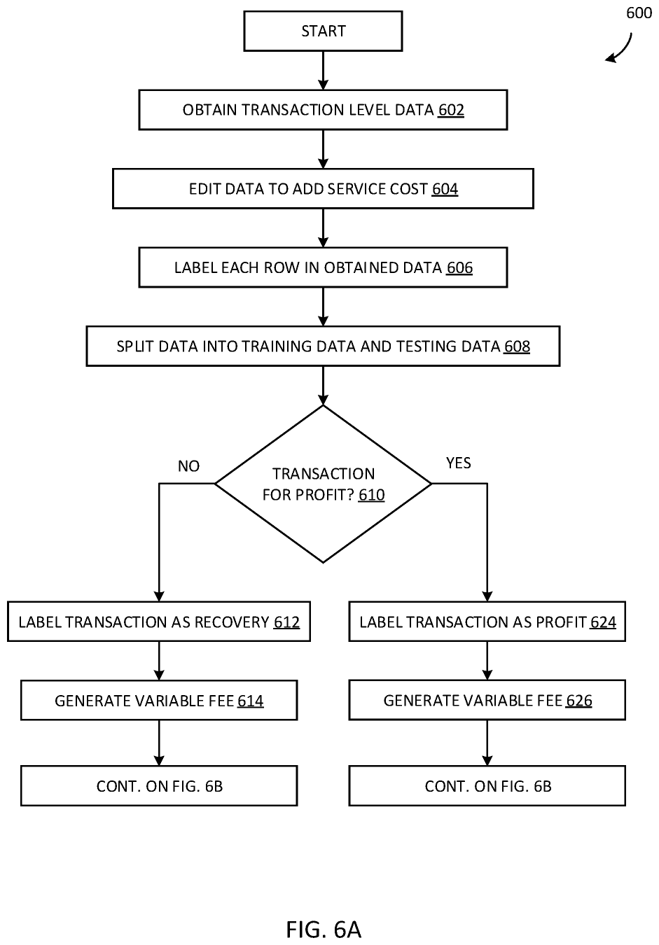

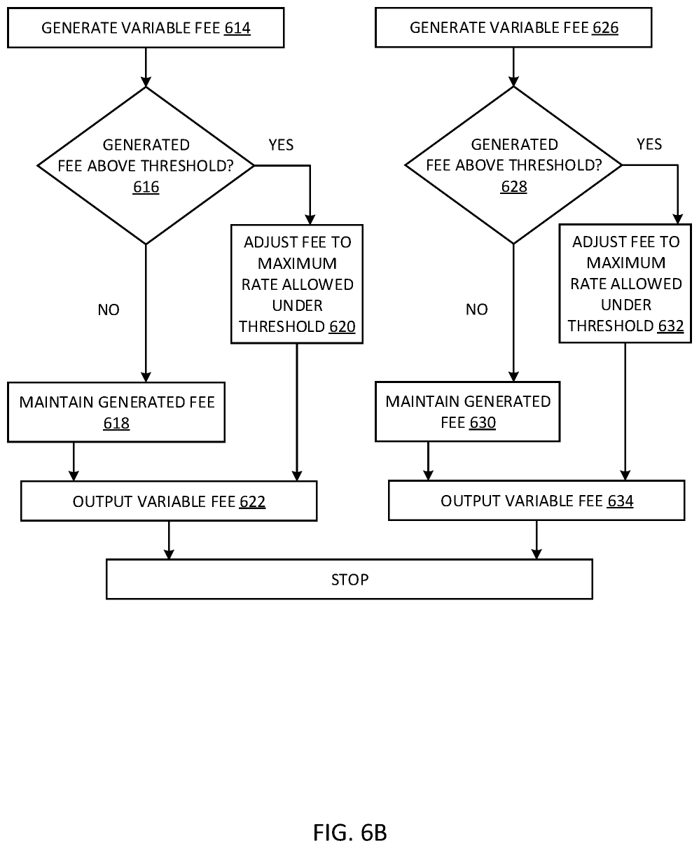

Based on the model validating and testing phase, the second scenario model 318b classifies the transaction as either a profit type transaction or a recovery type transaction and generates the variable fee based on the classification. For example, the second scenario model 318b generates the variable fee as the maximum variable fee set by the issuer 108 where the transaction is classified as a profit transaction and generates the variable fee as equal to the operational cost to the issuer 108 where the transaction is classified as a recovery transaction. The second scenario model 318b is described in greater detail below with regards to FIGS. 6A-6B.

The third scenario model 318c is a ML model that identifies the variable fee for a transaction identified as a third scenario transaction, which is a transaction that has medium approval and fraud amounts. In third scenario transactions, the third scenario model 318c identifies a group of issuers 108 similar to the issuer 108 in the particular transaction and generates a variable fee equal or similar to the variable fees used by the similar issuers 108 in similar transactions. The third scenario model 318c includes a data preparation stage and a ML model stage. In the data preparation stage, the third scenario model 318c prepares a first dataset and a second dataset. The first dataset is an institution-level, or bank-level, dataset that includes values such as issuer 108 country, issuer 108 name, transaction count, transaction amount, cross-border volume, whether a transaction was fraudulent, and so forth. The second dataset is a dimension-level dataset that includes values such as issuer 108 country, issuer name, DCC, merchant country, MCC, card portfolio, card present code, and variable fee. The second dataset is used to identify the variable fee applied by the particular institution based on a particular dimension. In some examples, the data preparation stage includes preparing the first and second datasets for multiple institutions, such as the issuer 108 and the acquirer 106.

In the ML model stage, the third scenario model 318c trains a ML model to identify peer groups for a transaction and then determines a variable fee for the transaction based on the identified peer groups. In some examples, the third scenario model 318c executes a clustering algorithm, such as a k-means clustering algorithm, on the first dataset to cluster similar institutions and thus identify peer institutions and transactions for a particular transaction. As referenced herein, a k-means clustering algorithm is an example of an unsupervised ML model that uses vector quantization to partition a number n of observations into k clusters. In each k cluster, each observation belongs to the cluster with the nearest mean, serving as a prototype of the cluster. In some examples, the third scenario model 318c identifies an optimal number of clusters to be formed. For example, the third scenario model 318c may implement a silhouette method, a solid state drive (SSD) method, or any other suitable method to determine the optimal number of clusters to be formed from the training dataset. Accordingly, the third scenario model 318c identifies the peer group of the issuer 108 of the incoming transaction based on the cluster in which the institution belongs.

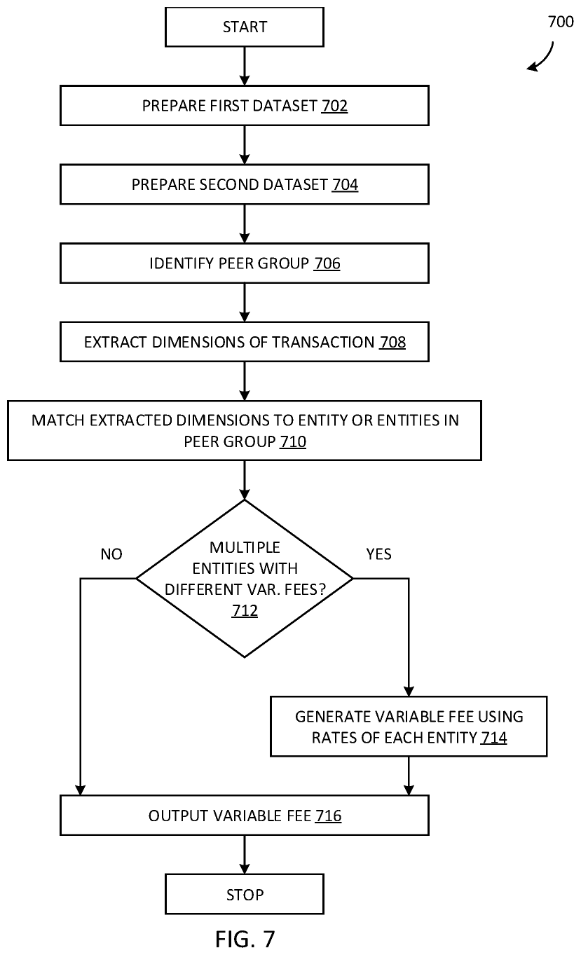

To determine the variable fee for the transaction, the third scenario model 318c uses the second dataset upon the cluster of the institution being identified. For example, the third scenario model 318c extracts the dimensions of the transaction and matches the extracted dimensions to other institutions present in the cluster. In some examples, the other institutions in the cluster have a same variable fee and that variable fee is selected. In other examples, the other institutions in the cluster do not have a same variable fee. In these examples, the third scenario model 318c calculates an average of the variable fees of the institutions in the cluster. The calculated average is determined as the variable fee for the transaction and output. The third scenario model 318c is described in greater detail below with regards to FIG. 7.

The tester 320 is a ML model that compares the variable fee determined by the first model 318, i.e., one of the first scenario model 318a, the second scenario model 318b, and the third scenario model 318c, with the variable fee in the clearing cycle to evaluate the first model 318. The tester 320 compares each of the determined variable fee and the variable fee in the clearing cycle on issuer profit and customer experience. In examples where the issuer's variable fee outperforms the variable fee output by the first model 318, the first model 318 is retrained using historical data, such as previous variable fees for similar transactions. In some examples, the model is retrained at regular intervals, such as every month, every two months, every three months, every six months, and so forth.

For example, the tester 320 validates and further tests the first model 318 by executing a pilot for the issuer 108. By executing the pilot run, the tester 320 determines whether a profit is increased by applying the variable fee and whether a customer experience is increased by applying the variable fee. To execute the pilot run, the tester 320 implements a sample of historical cross-border transactional data that passes through the entire ML data model 316, i.e., the first model 318 and the tester 320, and then outputs a sample variable fee for each transaction in the historical cross-border transactional data. This output fee is validated and checked against existing variable fees in both the area of profit made by the issuer 108 and the area of customer experience (e.g., via feedback surveys, quantity of complaints, etc.). In examples where the output fee improves each of the profit made by the issuer 108 and customer experience validates that the ML data model 316 is an improvement over existing processes of variable fee application methodology. Accordingly, the tester 320 provides an improvement over existing technology that not only continually improves the ML data model 316, and therefore the AI model 300, itself, but also the system 200 and computing device 202 that implements the ML data model 316 by improving profits made by the issuer 108, improving the customer experience by a quantifiable margin, and confirming an improvement over existing methodologies implemented by the issuer 108.

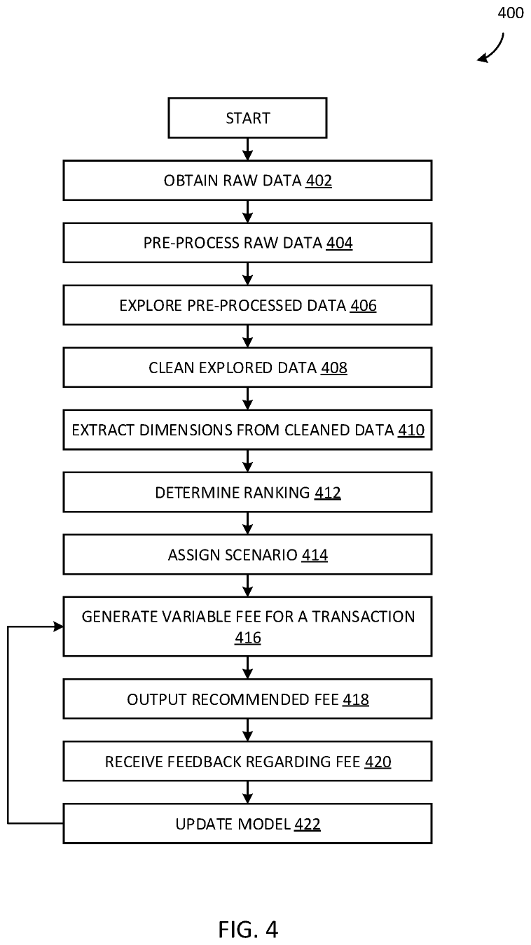

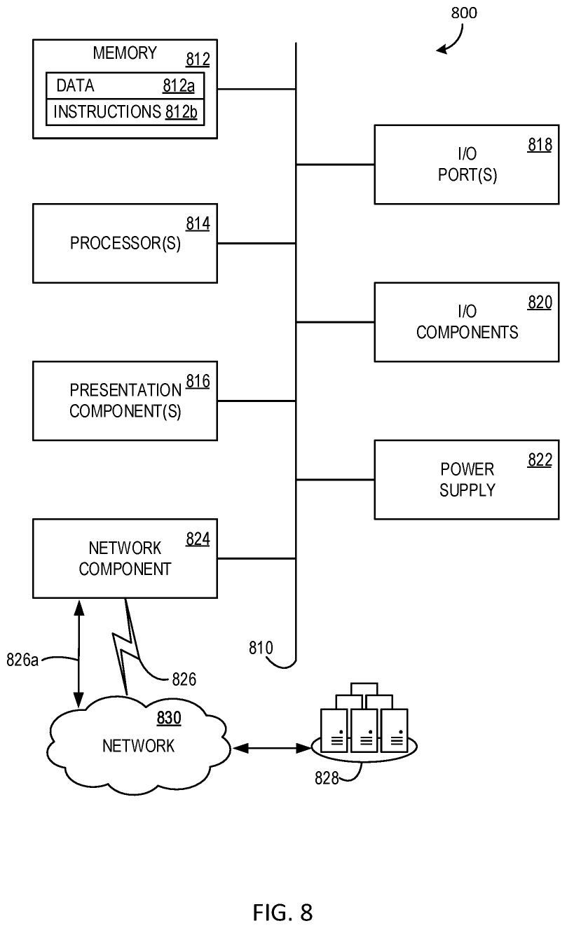

FIG. 4 is an example computerized method of dynamically computing a variable fee for cross-border transactions. The method 400 illustrated in FIG. 4 is for illustration only. Other examples of the method 400 may be used without departing from the scope of the present disclosure. The method 400 may be implemented by one or more components of the system 100 illustrated in FIG. 1, the system 200 illustrated in FIG. 2, or the AI model 300 illustrated in FIG. 3, such as the components of the example computing device 800 described in greater detail below in the description of FIG. 8.

The method 400 begins by the variable fee manager 222 obtaining raw data in operation 402 associated with one or more transactions. The raw data may be the raw data 216 that has been received and not yet processed, explored, or cleaned. For example, the raw data 216 includes one or more of issuer 108 details, including an identifier, name, address, and account information, merchant details, including an identifier, name, address, and account information, acquirer details, including an identifier, name, address, and account information, cardholder details, including an identifier, name, address, and account information, and transaction details, including the cardholder, merchant 110, issuer 108, acquirer 106, location of the transaction, date of the transaction, transaction amount, and transaction category. In some examples, the raw data is obtained by receiving the data for one or more transactions. In other examples, the raw data is obtained by accessing the raw data stored in the data storage device 214.

In operation 404, the data pre-processor 304 pre-processes the raw data 216. The data pre-processor 304 identifies a data format of the raw data, standardizes the data format of the data to address mismatches in the data format(s) of the raw data 216 so data is in a single, standardized format, and fixes any mismatched data values of the raw data 216 by recognizing and correcting discrepancies in the raw data 216.

In operation 406, the data explorer 306 explores the pre-processed data. For example, the data explorer 306 analyzes the pre-processed data using data visualization and statistical techniques and outputs characterizations of the pre-processed dataset. The output characterization provides context for the nature of the data. In some examples, the output characterizations may include one or more of a size of the data, quantity of the data, and accuracy of the data.

In operation 408, the data cleaner 308 cleans the explored data. For example, the data cleaner 308 removes or modifies any data that is identified as an outlier, including data that is incorrect, incomplete, irrelevant, duplicated, or improperly formatted to prepare the explored data for analysis by the ML data model 316.

In operation 410, the data preparer 312 extracts dimensions from the cleaned data. In some examples, the extracted dimensions include one or more of an issuer country, dynamic currency conversion (DCC) value, merchant country, merchant country conversion (MCC), card portfolio, card presenting code, approval amount, fraud rate, and so forth. In operation 412, the data preparer 312 determines a ranking of the transactions in the cleaned data. For example, the data preparer 312 ranks the transactions in descending order of the approved amounts for the transactions and in ascending order of fraud rates, and then determines a ratio of approved amount to fraud rate for each transaction based on the original rankings. The transactions are then re-ranked using the ratio of maximum approved amounts to the likelihood fraud. In some examples, re-ranking the transaction includes separating the transactions into tiers based on preset thresholds. For example, transactions in the top twenty percent may be assigned as the first scenario, transactions in the bottom twenty percent may be assigned as the second scenario, and transactions in the middle sixty percent may be assigned as the third scenario. However, these example thresholds are presented for illustration only and should not be construed as limiting.

In operation 414, the scenario assigner 314 assigns a scenario to a particular transaction based on the tier in which the transaction is found. For example, a first tier includes scenarios that include the highest ranking dimensions/categories with a maximum approved amount and least fraud, a third tier includes scenarios that include the lowest ranking dimensions/categories that have a maximum fraud and a least approved amount, and a second tier includes scenarios that include the remaining transactions that have medium approval and fraud amounts. The second tier is provided below the first tier in the ranking and above the third tier in the ranking. Assigning the scenario includes identifying the transaction within the first tier, the second tier, or the third tier, and assigning the transaction to the particular scenario associated with the tier in which the transaction is identified. For example, the transaction may be identified within the tier by a transaction identifier (ID).

In operation 416, the first model 318 generates the variable fee for a particular transaction based on the assigned scenario for the transaction. For example, the first scenario model 318a is used to generate the variable fee for transactions in the first scenario, the second scenario model 318b is used to generate the variable fee for transactions in the second scenario, and the third scenario model 318c is used to generate the variable fee for transactions in the third scenario. Various examples of methods used by the first scenario model 318a, the second scenario model 318b, and the third scenario model 318c to generate the variable fee for a transaction are described in greater detail below with regards to FIGS. 5-7, respectively.

In operation 418, the communications interface device 212 outputs the variable fee generated by the AI model 300. In some examples, the variable fee is output to the issuer 108 for confirmation. For example, the issuer 108 chooses to either implement the variable fee generated by the AI model 300 or to reject the generated variable fee and use a different fee for the transaction.

In operation 420, the communications interface device 212 receives feedback from the issuer 108 regarding the generated variable fee. The feedback includes an indication of whether the generated variable fee was selected for the transaction or whether the generated variable fee was not selected for the transaction. In examples where the generated variable fee was not selected for the transaction, the feedback further includes a second indication of the variable fee ultimately used for the transaction.

In operation 422, the AI model 300 is updated based on the feedback received from the issuer 108 regarding the generated variable fee. For example, the selected variable fee is stored as historical data, such as variable fee data 220, and used as feedback for the AI model 300. Based on the received feedback, various aspects of the AI model 300 are continually updated and optimized based on the training data, testing data, and historical data. For example, the AI model 300 may update one or more of the threshold distributions that separate the first scenario, second scenario, and third scenario, the rule-based engine 310, the first scenario model 318a, the second scenario model 318b, the third scenario model 318c, or the tester 320 based on the received feedback.

FIG. 5 is an example computerized method of executing a model that dynamically computes a variable fee for cross-border transactions in the first scenario. The method 500 illustrated in FIG. 5 is for illustration only. Other examples of the method 500 may be used without departing from the scope of the present disclosure. The method 500 may be implemented by one or more components of the system 100 illustrated in FIG. 1, the system 200 illustrated in FIG. 2, or the AI model 300 illustrated in FIG. 3, such as the components of the example computing device 800 described in greater detail below in the description of FIG. 8. In some examples, the method 500 is performed by the first scenario model 318a to generate a variable fee for a transaction assigned as a first scenario transaction in operation 416 of FIG. 4 as described above.

The method 500 begins by the first scenario model 318a preparing a dataset to identify dimensions of a transaction in operation 502. To prepare the dataset, the first scenario model 318a aggregates transaction level data at the level of dimensions of the transaction, such as the issuer 108 country, issuer 108 name, DCC, merchant 110 country, MCC, card portfolio, card present code, and mark-up information. In operation 504, the first scenario model 318a analyzes various the prepared dataset through the lens of several factors, including the range of fee applied by the issuer 108 at the selected dimensions, the minimum fee applied by the issuer 108, and the fee applied by all issuers 108 at the selected dimensions to identify the dimensions of the transactions.

In operation 506, the first scenario model 318a generates a variable fee for the transaction based on the analysis of the data using the factors. In some examples, the first scenario model 318a selects the minimum variable fee among the factors of range of fee applied by the issuer 108 at the selected dimensions, the minimum fee applied by the issuer 108, and the fee applied by all issuers 108 at the selected dimensions and generates the variable fee as the selected minimum variable fee.

In operation 508, the first scenario model 318a determines whether the selected variable is above a threshold. In some examples, the threshold is a maximum variable fee that can be used for the respective transaction based on one or more of a cardholder agreement, geographic-specific guidelines, issuer guidelines, and so forth. By checking the selected fee against the threshold, the first scenario model 318a ensures that the variable fee generated and selected falls within allowable parameters for the transaction.

Where the selected variable fee is not above the threshold, the selected fee is maintained in operation 510. Where the selected variable fee is above the threshold, the selected fee is adjusted to the maximum variable fee allowed under the threshold in operation 512. In operation 514, the variable fee is output to the tester 320 as described herein. Upon the completion of operation 514, the method 500 terminates.

FIGS. 6A-6B are an example computerized method of executing a ML model that dynamically computes a variable fee for cross-border transactions in a scenario. These flowcharts illustrate various options, not all of which are required for any one implementation. The method 600 illustrated in FIGS. 6A and 6B is for illustration only. FIG. 6B extends FIG. 6A and is a continuation of the method 600 which begins in FIG. 6A. Other examples of the method 600 can be used without departing from the scope of the present disclosure. The method 600 can be implemented by one or more components of the system 100 illustrated in FIG. 1 or the system 200 illustrated in FIG. 2, such as the components of the example computing device 800 described in greater detail below in the description of FIG. 8. In some examples, the method 600 is performed by the second scenario model 318b to generate a variable fee for a transaction assigned as a second scenario transaction in operation 416 of FIG. 4 as described above.

The method 600 begins by the second scenario model 318b obtaining transaction level data for a transaction in operation 602. The transaction level data includes the dimensions of the transaction, including the issuer 108 country, issuer 108 name, DCC, merchant country, MCC, card portfolio, card present code, and mark-up information. In operation 604, the second scenario model 318b edits the obtained transaction level data to include operational costs charged by the provider for the transaction. The operational cost is the cost incurred by the issuer 108 to service the transaction as a cross-border transaction. The operational cost is determined and applied by the payment network.

In operation 606, the second scenario model 318b labels, or categorizes, each row in the edited transaction level data. In some examples, labeling the rows includes labeling each row as either a profit transaction or a recovery transaction. For example, the second scenario model 318b labels the row as profit where the mark-up for the transaction is greater than the operational cost for the transaction and labels the row as recovery where the mark-up for the transaction is equal to the operational cost for the transaction. In operation 608, the second scenario model 318b splits, or separates, the labeled data into training and testing datasets. In some examples, the labeled data is separated based on predetermined percentages. For example, eighty percent of the prepared dataset is used as training data and twenty percent of the prepared dataset is used as testing data, where the first eighty percent of the rows of labeled data is used as the training data and the remaining twenty percent of the prepared dataset is used as the test data. In other examples, seventy percent of the prepared dataset is used as training data, seventy-five percent of the prepared dataset is used as training data, eighty-five percent of the prepared dataset is used as training data, or any other suitable amount is used as the training data.

In operation 608, the second scenario model 318b determines whether a particular transaction is a profit transaction or not a profit transaction, i.e., a recovery transaction. In some examples, the second scenario model 318b implements a decision tree ML model that uses a tree-like model of decisions and all possible consequences, including chance event outcomes, resource costs, and utility, to determine whether each transaction is a profit transaction or a recovery transaction. Where the transaction is not a profit transaction, the method 600 proceeds to operation 612. Where the transaction is a profit transaction, the method 600 proceeds to operation 624.

In operation 612, the\second scenario model 318b labels the transaction as a recovery transaction. In operation 614, the second scenario model 318b generates the variable fee for the transaction. In some examples, the second scenario model 318b generates the variable fee for the recovery transaction as equal to the operational cost for the issuer 108.

In operation 616, the second scenario model 318b determines whether the generated fee is above a threshold. In some examples, the threshold is a maximum variable fee that can be used for the respective transaction based on one or more of a cardholder agreement, geographic-specific guidelines, issuer guidelines, and so forth. By checking the selected fee against the threshold, the second scenario model 318b ensures that the variable fee generated and selected falls within allowable parameters for the transaction. Where the generated fee is not above the threshold, the second scenario model 318b maintains the generated fee at operation 618. Where the generated fee is above the threshold, the second scenario model 318b adjusts the fee to the maximum variable fee allowed under the threshold in operation 620. In operation 622, the second scenario model 318b outputs the variable fee to the tester 320 as described herein.

In operation 624, based on the transaction being determined to be a profit transaction, the second scenario model 318b labels the transaction as a profit transaction. In operation 626, the second scenario model 318b generates the variable fee for the transaction. In some examples, the second scenario model 318b generates the variable fee for the recovery transaction as the maximum fee set by the issuer 108 for the particular transaction.

In operation 628, the second scenario model 318b determines whether the generated fee is above a threshold. In some examples, the threshold is a maximum variable fee that can be used for the respective transaction based on one or more of a cardholder agreement, geographic-specific guidelines, issuer guidelines, and so forth. By checking the selected fee against the threshold, the second scenario model 318b ensures that the variable fee generated and selected falls within allowable parameters for the transaction. Where the generated fee is not above the threshold, the second scenario model 318b maintains the generated fee at operation 630. Where the generated fee is above the threshold, the second scenario model 318b adjusts the fee to the maximum variable fee allowed under the threshold in operation 632. In operation 634, the second scenario model 318b outputs the variable fee to the tester 320 as described herein. Upon the respective variable fee being output in operation 622 or 634, the method 600 terminates.

FIG. 7 is an example computerized method of executing a ML model that dynamically computes a variable fee for cross-border transactions in a scenario. The method 700 illustrated in FIG. 7 is for illustration only. Other examples of the method 700 may be used without departing from the scope of the present disclosure. The method 700 may be implemented by one or more components of the system 100 illustrated in FIG. 1, the system 200 illustrated in FIG. 2, or the AI model 300 illustrated in FIG. 3, such as the components of the example computing device 800 described in greater detail below in the description of FIG. 8. In some examples, the method 700 is performed by the third scenario model 318c to generate a variable fee for a transaction assigned as a third scenario transaction in operation 416 of FIG. 4 as described above.

The method 700 begins by the third scenario model 318c preparing a first dataset in operation 702. In some examples, the first dataset is an institution-level, or bank-level, dataset that includes values such as issuer 108 country, issuer 108 name, transaction count, transaction amount, cross-border volume, whether a transaction was fraudulent, and so forth. In operation 704, the third scenario model 318c prepares a second dataset, different from the first dataset. In some examples, the second dataset is a dimension-level dataset that includes values such as issuer 108 country, issuer 108 name, DCC, merchant country, MCC, card portfolio, card present code, and variable fee. The second dataset is used to identify the variable fee applied by the particular institution based on a particular dimension. Although described herein as occurring in separate steps, variable examples are possible without departing from the scope of the present disclosure. For example, operations 702 and 704 may occur simultaneously, operation 702 may be performed prior to operation 704, or operation 704 may be performed prior to operation 702 without departing from the scope of the present disclosure.

In operation 706, the third scenario model 318c identifies a peer group for a transaction. In some examples, the third scenario model 318c executes a clustering algorithm, such as a k-means clustering algorithm, on the first dataset to cluster similar institutions and thus identify peer institutions and transactions for a particular transaction. As referenced herein, a k-means clustering algorithm is an example of an unsupervised ML model that uses vector quantization to partition a number n of observations into k clusters. In each k cluster, each observation belongs to the cluster with the nearest mean, serving as a prototype of the cluster. In some examples, the third scenario model 318c identifies an optimal number of clusters to be formed. For example, the third scenario model 318c may implement a silhouette method, a solid state drive (SSD) method, or any other suitable method to determine the optimal number of clusters to be formed from the training dataset. Accordingly, the third scenario model 318c identifies the peer group of the issuer 108 of the incoming transaction based on the cluster in which the institution belongs.

In operation 708, the third scenario model 318c extracts dimensions of the particular transaction from the second dataset to identify the cluster in which the institution is included. In operation 710, the third scenario model 318c matches the extracted dimensions of the transaction to another entity or other entities in the peer group in order to determine the variable fee used for similar institutions in similar transactions, i.e., in the peer group of the institution of the particular transaction.

In operation 712, the third scenario model 318c determines whether there are multiple entities with different variable fees within the identified peer group. Where the third scenario model 318c identifies there are multiple entities in the peer group that have different variable fees, the third scenario model 318c generates the variable fee by generating the average of the different historical variable fees and applying that fee in operation 714. The generated variable fee is then output in operation 716. In examples where the third scenario model 318c identifies there are not multiple entities in the peer group that have different variable fees, the third scenario model 318c progresses directly to operation 716 and applies the historical variable fee of the entities in the peer group.

In some examples, outputting the variable fee in operation 716 includes outputting the variable fee to the issuer 108 processing the pending transaction. In some examples, outputting the variable fee to the issuer 108 includes transmitting, via the communications interface device 212, the variable fee to a computing device of the issuer 108 over a network, such as the network 232. In some examples, outputting the variable fee to the computing device of the issuer 108 causes the issuer 108 to process the pending transaction using the output recommended variable fee. Upon outputting the generated variable fee, the method 700 terminates.

### Example Operating Environment

FIG. 8 is a block diagram of an example computing device 800 for implementing aspects disclosed herein and is designated generally as computing device 800. Computing device 800 is an example of a suitable computing environment and is not intended to suggest any limitation as to the scope of use or functionality of the examples disclosed herein. Neither should computing device 800 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

In some examples, the computing device 800 is the computing device 202. Accordingly, the memory 812, the processor 814, the presentation component(s) 816, and the network 830 can be the memory 204, the processor 208, the user interface 210, and the network 232, respectively. However, these examples should not be construed as limiting. Various examples are possible.

Computing device 800 includes a bus 810 that directly or indirectly couples the following devices: computer-storage memory 812, one or more processors 814, one or more presentation components 816, I/O ports 818, I/O components 820, a power supply 822, and a network component 824. While computing device 800 is depicted as a seemingly single device, multiple computing devices 800 may work together and share the depicted device resources. For example, memory 812 may be distributed across multiple devices, and processor(s) 814 may be housed with different devices.

Bus 810 represents what may be one or more busses (such as an address bus, data bus, or a combination thereof). Although the various blocks of FIG. 8 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 8 and the references herein to a “computing device.” Memory 812 may take the form of the computer storage media references below and operatively provide storage of computer-readable instructions, data structures, program modules and other data for computing device 800. In some examples, memory 812 stores one or more of an operating system, a universal application platform, or other program modules and program data. Memory 812 is thus able to store and access data 812a and instructions 812b that are executable by processor 814 and configured to carry out the various operations disclosed herein.

In some examples, memory 812 includes computer storage media in the form of volatile and/or nonvolatile memory, removable or non-removable memory, data disks in virtual environments, or a combination thereof. Memory 812 may include any quantity of memory associated with or accessible by computing device 800. Memory 812 may be internal to computing device 800, external to computing device 800, or both. Examples of memory 812 in include, without limitation, random access memory (RAM); read only memory (ROM); electronically erasable programmable read only memory (EEPROM); flash memory or other memory technologies; CD-ROM, digital versatile disks (DVDs) or other optical or holographic media; magnetic cassettes, magnetic tape, magnetic disk storage or other magnetic storage devices; memory wired into an analog computing device; or any other medium for encoding desired information and for access by computing device 800. Additionally, or alternatively, memory 812 may be distributed across multiple computing devices 800, for example, in a virtualized environment in which instruction processing is carried out on multiple computing devices 800. For the purposes of this disclosure, “computer storage media,” “computer-storage memory,” “memory,” and “memory devices” are synonymous terms for computer-storage memory 812, and none of these terms include carrier waves or propagating signaling.

Processor(s) 814 may include any quantity of processing units that read data from various entities, such as memory 812 or I/O components 820 and may include CPUs and/or GPUs. Specifically, processor(s) 814 are programmed to execute computer-executable instructions for implementing aspects of the disclosure. The instructions may be performed by the processor, by multiple processors within computing device 800, or by a processor external to client computing device 800. In some examples, processor(s) 814 are programmed to execute instructions such as those illustrated in the in the accompanying drawings. Moreover, in some examples, processor(s) 814 represent an implementation of analog techniques to perform the operations described herein. For example, the operations may be performed by an analog client computing device 800 and/or a digital client computing device 800. Presentation component(s) 816 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 800, across a wired connection, or in other ways. I/O ports 818 allow computing device 800 to be logically coupled to other devices including I/O components 820, some of which may be built in. Example I/O components 820 include, for example but without limitation, a microphone, joystick, game pad, satellite dish, scanner, printer, wireless device, etc.

Computing device 800 may operate in a networked environment via network component 824 using logical connections to one or more remote computers. In some examples, network component 824 includes a network interface card and/or computer-executable instructions (e.g., a driver) for operating the network interface card. Communication between computing device 800 and other devices may occur using any protocol or mechanism over any wired or wireless connection. In some examples, network component 824 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 824 communicates over wireless communication link 826 and/or a wired communication link 826a to a cloud resource 828 across network 830. Various different examples of communication links 826 and 826a include a wireless connection, a wired connection, and/or a dedicated link, and in some examples, at least a portion is routed through the internet.

Although described in connection with an example computing device, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality (MR) devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are non-transitory and not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

Alternatively, or in addition to the other examples described herein, examples include any combination of the following:
preparing raw data for analysis by a scenario-specific model, the raw data associated with a pending transaction;
assigning the pending transaction to a scenario;
generating, by a scenario-specific model, a recommended variable fee for the pending transaction based on the prepared data;
outputting the recommended variable fee to an issuer processing the pending transaction;
receiving feedback from the issuer regarding the recommended variable fee;
training the scenario-specific model using the received feedback;
obtaining the raw data associated with the pending transaction,
the obtained raw data is associated with a plurality of transactions,
the plurality of transactions including the pending transaction;
ranking the plurality of transactions based on a ratio of maximum approved transaction amounts to fraud likelihood for each transaction, the ranking including a first tier of transactions, a second tier of transactions, and a third tier of transactions;
identifying the pending transaction as a transaction in the first tier of the ranking;
assigning the pending transaction to a first scenario associated with the first tier;
preparing a dataset including dimensions of the pending transaction;
analyzing the dimensions to determine a minimum variable fee for the pending transaction;
generating the recommended variable fee as the minimum variable fee;
identifying the pending transaction as a transaction in the second tier of the ranking;
assigning the pending transaction to a second scenario associated with the second tier;
preparing a dataset including dimensions of the pending transaction;
modifying the dimensions to include operational costs for the pending transaction;
categorizing the pending transaction as either a profit transaction or a cost recovery transaction;
generating the recommended variable fee as a maximum variable fee, wherein the maximum variable fee is a fee defined by the issuer;
comparing the generated recommended variable fee to a threshold fee;
based on the generated recommended variable fee being less than or equal to the threshold fee, maintaining the generated recommend variable fee;
based on the generated recommended variable fee being greater than the threshold fee, adjusting the generated recommended variable fee to a maximum permitted variable fee under the threshold fee and outputting the adjusted variable fee to the issuer;
generating the recommended variable fee as a variable fee equal to an operational cost to the issuer for the pending transaction;
identifying the pending transaction as a transaction in the third tier of the ranking;
assigning the pending transaction to a third scenario associated with the third tier;
identifying a peer group from the plurality of transactions, the peer group comprising transactions executed by a peer institution;
generating the variable fee based on historical variable fees from the transactions executed by the peer institution;
pre-processing the raw data;
exploring the pre-processed data;
cleaning the explored data;
causing the issuer to process the pending transaction using the output recommended variable fee; and
outputting the recommended variable fee to the issuer further comprises transmitting the recommended variable fee over a network to an issuer computer.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

What is claimed is:

1. A computer-implemented method, comprising:
preparing raw data for analysis by a scenario-specific model, the raw data associated with a pending transaction;
assigning the pending transaction to a scenario;
generating, by the scenario-specific model, a recommended variable fee for the pending transaction based on the prepared data; and
outputting the recommended variable fee to an issuer processing the pending transaction.

2. The computer-implemented method of claim 1, further comprising:
receiving feedback from the issuer regarding the recommended variable fee; and
training the scenario-specific model using the received feedback.

3. The computer-implemented method of claim 1, further comprising:
obtaining the raw data associated with the pending transaction, wherein the obtained raw data is associated with a plurality of transactions, and wherein the plurality of transactions include the pending transaction, and
ranking the plurality of transactions based on a ratio of maximum approved transaction amounts to fraud likelihood for each transaction, the ranking including a first tier of transactions, a second tier of transactions, and a third tier of transactions.

4. The computer-implemented method of claim 3, wherein assigning the transaction to the scenario further comprises:
identifying the pending transaction as a transaction in the first tier of the ranking, and
assigning the pending transaction to a first scenario associated with the first tier.

5. The computer-implemented method of claim 4, wherein generating the recommended variable further comprises:
preparing a dataset including dimensions of the pending transaction;
analyzing the dimensions to determine a minimum variable fee for the pending transaction; and
generating the recommended variable fee as the minimum variable fee.

6. The computer-implemented method of claim 3, wherein assigning the transaction to the scenario further comprises:
identifying the pending transaction as a transaction in the second tier of the ranking, and
assigning the pending transaction to a second scenario associated with the second tier.

7. The computer-implemented method of claim 6, wherein generating the recommended variable further comprises:
preparing a dataset including dimensions of the pending transaction;
modifying the dimensions to include operational costs for the pending transaction; and
categorizing the pending transaction as either a profit transaction or a cost recovery transaction.

8. The computer-implemented method of claim 7, wherein, based on the pending transaction being categorized as the profit transaction, the computer-implemented method further comprises:
generating the recommended variable fee as a maximum variable fee, wherein the maximum variable fee is a fee defined by the issuer.

9. The computer-implemented method of claim 8, further comprising:
comparing the generated recommended variable fee to a threshold fee;
based on the generated recommended variable fee being less than or equal to the threshold fee, maintaining the generated recommend variable fee; and
based on the generated recommended variable fee being greater than the threshold fee, adjusting the generated recommended variable fee to a maximum permitted variable fee under the threshold fee and outputting the adjusted variable fee to the issuer.

10. The computer-implemented method of claim 7, wherein, based on the pending transaction being categorized as the cost recovery transaction, the computer-implemented method further comprises:
generating the recommended variable fee as a variable fee equal to an operational cost to the issuer for the pending transaction.

11. The computer-implemented method of claim 3, wherein assigning the transaction to the scenario further comprises:
identifying the pending transaction as a transaction in the third tier of the ranking, and
assigning the pending transaction to a third scenario associated with the third tier.

12. The computer-implemented method of claim 11, wherein generating the recommended variable further comprises:
identifying a peer group from the plurality of transactions, the peer group comprising transactions executed by a peer institution; and
generating the variable fee based on historical variable fees from the transactions executed by the peer institution.

13. The computer-implemented method of claim 1, wherein preparing the raw data further comprises:
pre-processing the raw data;
exploring the pre-processed data; and
cleaning the explored data.

14. The computer-implemented method of claim 1, further comprising:
causing the issuer to process the pending transaction using the output recommended variable fee.

15. The computer-implemented method of claim 1, wherein outputting the recommended variable fee to the issuer further comprises:
transmitting the recommended variable fee over a network to an issuer computer.

16. A system comprising:
a processor;
a communications interface; and
a memory storing instructions that, when executed by the processor, cause the processor to:
prepare raw data for analysis by a scenario-specific model, the raw data associated with a pending transaction, and a plurality of transactions including the pending transaction;
rank the plurality of transactions based on a ratio of maximum approved transaction amounts to fraud likelihood for each transaction, the ranking including a first tier of transactions, a second tier of transactions, and a third tier of transactions;
assign the pending transaction to a scenario based on the ranking;
generate, by the scenario-specific model implemented on the processor, a recommended variable fee for the pending transaction based on the prepared data; and
transmit, over a network, the recommended variable fee to an issuer processing the pending transaction.

17. The system of claim 16, wherein the instructions further cause the processor to, based on the pending transaction being assigned to a first scenario associated with the first tier, control the scenario-specific model to:
prepare a dataset including dimensions of the pending transaction;
analyze the dimensions to determine a minimum variable fee for the pending transaction; and
generate the recommended variable fee as the minimum variable fee.

18. The system of claim 16, wherein the instructions further cause the processor to, based on the pending transaction being assigned to a second scenario associated with the second tier, control the scenario-specific to:
prepare a dataset including dimensions of the pending transaction;
modify the dimensions to include operational costs for the pending transaction;
categorize the pending transaction as either a profit transaction or a cost recovery transaction;
based on the pending transaction being categorized as the profit transaction, generate the recommended variable fee as a maximum variable fee, wherein the maximum variable fee is a fee defined by the issuer; and
based on the pending transaction being categorized as the cost recovery transaction, generate the recommended variable fee as a variable fee equal to an operational cost to the issuer for the pending transaction.

19. The system of claim 16, wherein the instructions further cause the processor to, based on the pending transaction being assigned to a third scenario associated with the third tier, control the scenario-specific to:
identify a peer group from the plurality of transactions, the peer group comprising transactions executed by a peer institution; and
generate the variable fee based on historical variable fees from the transactions executed by the peer institution.

20. A computer-readable medium storing instructions that, when executed by a processor, cause the processor to:
prepare raw data for analysis by a scenario-specific model, the raw data associated with a pending transaction, and a plurality of transactions including the pending transaction;
rank the plurality of transactions based on a ratio of maximum approved transaction amounts to fraud likelihood for each transaction, the ranking including a first tier of transactions, a second tier of transactions, and a third tier of transactions;
assign the pending transaction to a scenario based on the ranking;
generate, by the scenario-specific model implemented on the processor, a recommended variable fee for the pending transaction based on the prepared data;
output the recommended variable fee to an issuer processing the pending transaction;
receive feedback from the issuer regarding the recommended variable fee; and
train the scenario-specific model using the received feedback.
